(19) United States
(12) Patent Application Publication
(10) Pub. No.: US 2012/0156015 A1
(43) Pub. Date: Jun. 21, 2012

(54) SUPERSONIC COMPRESSOR AND METHOD OF ASSEMBLING SAME

(76) Inventors: Ravindra Gopaldas Devi, Bangalore (IN); Douglas Carl Hofer, Clifton Park, NY (US); Zachary William Nagel, Ballston Lake, NY (US); David Graham Holmes, Schenectady, NY (US)

(21) Appl. No.: 12/971,521

(22) Filed: Dec. 17, 2010

(51) Int. Cl. F04D 21/00; B23P 15/00

(52) U.S. Cl. 415/181; 29/888.02

(57) ABSTRACT

A supersonic compressor includes a fluid inlet and a fluid outlet, a fluid conduit extending therebetween, and a supersonic compressor rotor disposed within the fluid conduit. The rotor includes at least one rotor disk that includes a substantially cylindrical body extending between a radially inner and outer surface and a plurality of vanes coupled to the body that extend radially outward from the rotor disk and adjacent vanes form a pair of vanes. The rotor disk further includes a shroud extending about at least a portion of the rotor disk. The shroud is coupled to at least a portion of each of the plurality of vanes. The radially outer surface, the pair of adjacent vanes, and the shroud are oriented such that a fluid flow channel is defined therebetween. The rotor disk also includes a plurality of adjacent supersonic compression ramps positioned within the fluid flow channel.

### BACKGROUND

The subject matter described herein relates generally to supersonic compressor systems and, more particularly, to a supersonic compressor rotor for use with a supersonic compressor system.

At least some known supersonic compressor systems include a drive assembly, a drive shaft, and at least one supersonic compressor rotor for compressing a fluid. The drive assembly is coupled to the supersonic compressor rotor with the drive shaft to rotate the drive shaft and the supersonic compressor rotor.

Known supersonic compressor rotors include a plurality of vanes coupled to a rotor disk. Each vane is oriented circumferentially about the rotor disk and defines a flow channel between adjacent vanes. At least some known supersonic compressor rotors include a supersonic compression ramp that is coupled to the rotor disk. Known supersonic compression ramps are positioned within the flow path to form a throat region and are configured to form a compression wave within the flow path.

During operation of known supersonic compressor systems, the drive assembly rotates the supersonic compressor rotor at an initially low speed and accelerates the rotor to a high rotational speed. A fluid is channeled to the supersonic compressor rotor such that the fluid is characterized by a velocity that is initially subsonic with respect to the supersonic compressor rotor at the flow channel inlet and then, as the rotor accelerates, the fluid is characterized by a velocity that is supersonic with respect to the supersonic compressor rotor at the flow channel inlet. In known supersonic compressor rotors, as fluid is channeled through the flow channel, the supersonic compressor ramp causes formation of a system of oblique shockwaves within a converging portion of the flow channel and a normal shockwave in a diverging portion of the flow channel. A throat region is defined in the narrowest portion of the flow channel between the converging and diverging portions. Further, during operation of known supersonic compressor systems, fluid leakage across radially outermost portions of the vanes is one of the principal sources of efficiency loss for supersonic compressors, especially due to the large pressure gradients spanning the vanes. At least some known supersonic compressors have large physical footprints for a given flow capacity and pressurization ratio. Known supersonic compressor systems are described in, for example, U.S. Pat. Nos. 7,334,990 and 7,293,955 filed Mar. 28, 2005 and Mar. 23, 2005 respectively, and United States Patent Application 2009/0196731 filed Jan. 16, 2009.

### BRIEF DESCRIPTION OF THE INVENTION

In one aspect, a supersonic compressor is provided. The supersonic compressor includes a fluid inlet and a fluid outlet. The supersonic compressor also includes a fluid conduit extending between the fluid inlet and the fluid outlet. The supersonic compressor further includes at least one supersonic compressor rotor disposed within the fluid conduit of the supersonic compressor. The supersonic compressor rotor includes at least one rotor disk. The rotor disk has a substantially cylindrical body extending between a radially inner surface and a radially outer surface. The rotor disk also includes a plurality of vanes coupled to the body. The vanes extend radially outward from the at least one rotor disk and adjacent vanes form a pair of vanes. The rotor disk further includes a shroud extending about at least a portion of the at least one rotor disk. The shroud is coupled to at least a portion of each of the plurality of vanes. The radially outer surface, the pair of adjacent vanes, and the shroud are oriented such that a fluid flow channel is defined therebetween. The fluid flow channel includes a fluid inlet opening and a fluid outlet opening. The rotor disk also includes a plurality of adjacent supersonic compression ramps positioned within the fluid flow channel. Each of the plurality of adjacent supersonic compression ramps is configured to condition a fluid being channeled through the fluid flow channel such that the fluid is characterized by a first velocity at the inlet opening and a second velocity at the outlet opening. The first velocity is supersonic with respect to the rotor disk surfaces. The rotor disk further includes a casing extending about at least a portion of the shroud.

In another aspect, a supersonic compressor rotor is provided. The supersonic compressor rotor includes at least one rotor disk comprising a substantially cylindrical body extending between a radially inner surface and a radially outer surface. The supersonic compressor rotor also includes a plurality of vanes coupled to the body. The vanes extend radially outward from the at least one rotor disk and adjacent vanes form a pair of vanes. The supersonic compressor rotor further includes a shroud extending about at least a portion of the at least one rotor disk. The shroud is coupled to at least a portion of each of the plurality of vanes. The radially outer surface, the pair of adjacent vanes, and the shroud are oriented such that a fluid flow channel is defined therebetween. The fluid flow channel includes a fluid inlet opening and a fluid outlet opening. The supersonic compressor rotor also includes a plurality of adjacent supersonic compression ramps positioned within the fluid flow channel. Each of the plurality of adjacent supersonic compression ramps is configured to condition a fluid being channeled through the fluid flow channel such that the fluid is characterized by a first velocity at the inlet opening and a second velocity at the outlet opening. The first velocity is supersonic with respect to the rotor disk surfaces.

In yet another aspect, a method for assembling a supersonic compressor is provided. The method includes providing a casing that defines a fluid inlet, a fluid outlet, and a fluid conduit extending therebetween. The method also includes disposing at least one supersonic compressor rotor within the fluid conduit of the supersonic compressor. The method further includes providing at least one rotor disk that includes a substantially cylindrical body extending between a radially inner surface and a radially outer surface. The method also includes coupling a plurality of vanes to the body. The vanes extend radially outward from the at least one rotor disk and adjacent said vanes form a pair of vanes. The method further includes coupling a shroud to at least a portion of each of the plurality of vanes and extending the shroud about at least a portion of the at least one rotor disk. The casing extends about at least a portion of the shroud. The method also includes orienting the radially outer surface, the pair of adjacent vanes, and the shroud such that a fluid flow channel is defined therebetween. The fluid flow channel includes a fluid inlet opening and a fluid outlet opening. The method further includes positioning a plurality of adjacent supersonic compression ramps within the fluid flow channel. Each of the plurality of adjacent supersonic compression ramps is configured to condition a fluid being channeled through the fluid flow channel such that the fluid is characterized by a first velocity at the inlet opening and a second velocity at the outlet opening. The first velocity is supersonic with respect to the rotor disk surfaces.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an exemplary supersonic compressor system;

FIG. 2 is a perspective view of an exemplary supersonic compressor rotor that may be used with the supersonic compressor shown in FIG. 1;

FIG. 3 is an enlarged top view of a portion of the supersonic compressor rotor shown in FIG. 2 and taken along line 3-3;

FIG. 4 is a schematic view of a portion of a fluid flow channel that may be used with the supersonic compressor rotor shown in FIGS. 2 and 3;

FIG. 5 is a top view of the portion of the fluid flow channel shown in FIG. 4;

FIG. 6 is a channel-wise view of the portion of the fluid flow channel shown in FIGS. 4 and 5 and taken along line 6-6;

FIG. 7 is a schematic view of a portion of a fluid flow channel that may be used with the supersonic compressor rotor shown in FIGS. 2 and 3;

FIG. 8 is a channel-wise view of the portion of the fluid flow channel shown in FIG. 7 taken along line 8-8;

FIG. 9 is a schematic view of a portion of a fluid flow channel that may be used with the supersonic compressor rotor shown in FIGS. 2 and 3;

FIG. 10 is a channel-wise view of the portion of the fluid flow channel shown in FIG. 9 taken along line 10-10;

FIG. 11 is a schematic view of a portion of a fluid flow channel that may be used with the supersonic compressor rotor shown in FIGS. 2 and 3;

FIG. 12 is a channel-wise view of the portion of the fluid flow channel shown in FIG. 11 taken along line 12-12;

FIG. 13 is a channel-wise view of a portion of a fluid flow channel that may be used with the supersonic compressor rotor shown in FIGS. 2 and 3;

FIG. 14 is an enlarged top view of a portion of the supersonic compressor rotor shown in FIG. 2 and taken along line 14-14;

FIG. 15 is a schematic view of a portion of the supersonic compressor rotor shown in FIG. 14;

FIG. 16 is a schematic view of the portion of the supersonic compressor rotor shown in FIG. 14 taken along line 16-16;

FIG. 17 is a schematic view of a portion of an alternative supersonic compressor system; and

FIG. 18 is a schematic view of the portion of the supersonic compressor system shown in FIG. 17 taken along line 18-18.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION OF THE INVENTION

In the following specification and the claims, which follow, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “supersonic compressor rotor” refers to a compressor rotor comprising a supersonic compression ramp disposed within a fluid flow channel of the supersonic compressor rotor. Moreover, supersonic compressor rotors are “supersonic” because they are designed to rotate about an axis of rotation at high speeds such that a moving fluid, for example a moving gas, encountering the rotating supersonic compressor rotor at a supersonic compression ramp disposed within a flow channel of the rotor, is said to have a relative fluid velocity which is supersonic. The relative fluid velocity can be defined in terms of the vector sum of the rotor velocity at the supersonic compression ramp and the fluid velocity just prior to encountering the supersonic compression ramp. This relative fluid velocity is at times referred to as the “local supersonic inlet velocity”, which in certain embodiments is a combination of an inlet gas velocity and a tangential speed of a supersonic compression ramp disposed within a flow channel of the supersonic compressor rotor. The supersonic compressor rotors are engineered for service at very high tangential speeds, for example tangential speeds in a range of 300 meters/second to 800 meters/second.

The exemplary systems and methods described herein overcome disadvantages of known supersonic compressors by providing supersonic compressor rotor that increases an operating efficiency of a supersonic compressor system by reducing fluid flow losses across the radially outer portions of the vanes. More specifically, the supersonic compression rotor includes a shroud positioned over the radially outer tops of the vanes, thereby separating the plurality of fluid flow paths defined by adjacent vanes. Furthermore, axial and radial sealing devices further reduce a potential for fluid flow outside of predetermined fluid flow channels.

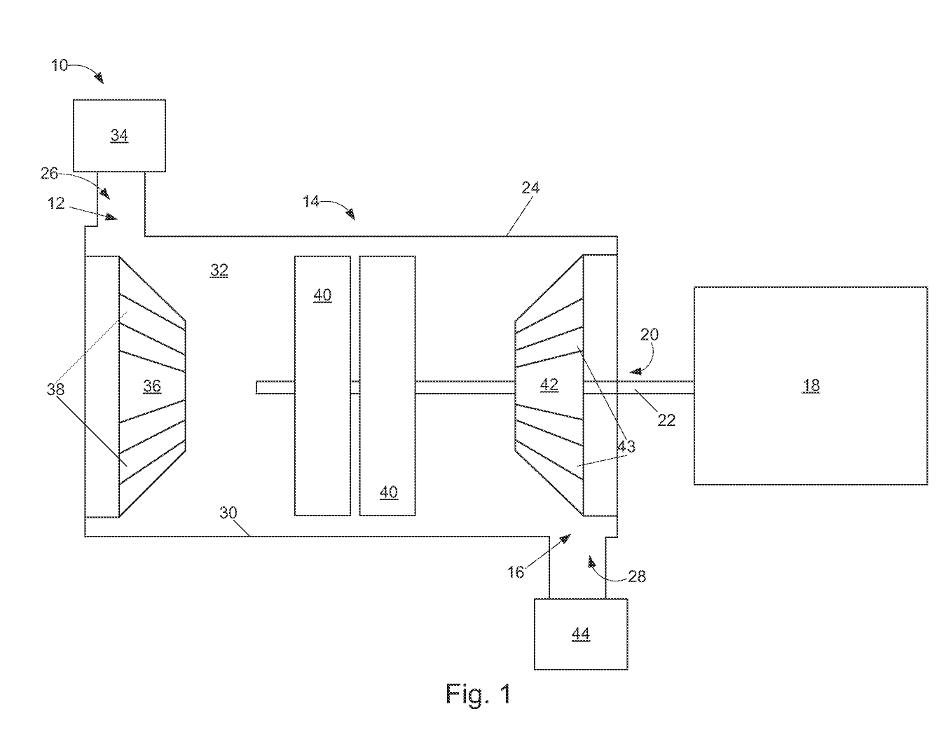

FIG. 1 is a schematic view of an exemplary supersonic compressor system 10. In the exemplary embodiment, supersonic compressor system 10 includes an intake section 12, a compressor section 14 coupled downstream from intake section 12, a discharge section 16 coupled downstream from compressor section 14, and a drive assembly 18. Compressor section 14 is coupled to drive assembly 18 by a rotor assembly 20 that includes a drive shaft 22. In the exemplary embodiment, each of intake section 12, compressor section 14, and discharge section 16 are positioned within a compressor housing 24. More specifically, compressor housing 24 includes a fluid inlet 26, a fluid outlet 28, and an inner surface 30 that defines a cavity 32. Cavity 32 extends between fluid inlet 26 and fluid outlet 28 and is configured to channel a fluid from fluid inlet 26 to fluid outlet 28. Each of intake section 12, compressor section 14, and discharge section 16 are positioned within cavity 32. Alternatively, intake section 12 and/or discharge section 16 may not be positioned within compressor housing 24.

In the exemplary embodiment, fluid inlet 26 is configured to channel a flow of fluid from a fluid source 34 to intake section 12. The fluid may be any fluid such as, for example a gas, a gas mixture, a particle-laden gas, and/or a liquid-gas mixture. Intake section 12 is coupled in flow communication with compressor section 14 for channeling fluid from fluid inlet 26 to compressor section 14. Intake section 12 is configured to condition a fluid flow having one or more predetermined parameters, such as a velocity, a mass flow rate, a pressure, a temperature, and/or any suitable flow parameter. In the exemplary embodiment, intake section 12 includes an inlet guide vane assembly 36 that is coupled to compressor housing 24 between fluid inlet 26 and compressor section 14 for channeling fluid from fluid inlet 26 to compressor section 14. Inlet guide vane assembly 36 includes one or more inlet guide vanes 38 that are stationary with respect to compressor section 14.

Compressor section 14 is coupled between intake section 12 and discharge section 16 for channeling at least a portion of fluid from intake section 12 to discharge section 16. Compressor section 14 includes at least one supersonic compressor rotor 40 that is rotatably coupled to drive shaft 22. Supersonic compressor rotor 40 is configured to increase a pressure of fluid, reduce a volume of fluid, and/or increase a temperature of fluid being channeled to discharge section 16. Discharge section 16 includes an outlet guide vane assembly 42 that is coupled to compressor housing 24 between supersonic compressor 10 and fluid outlet 28 for channeling fluid from supersonic compressor 10 to fluid outlet 28. Outlet guide vane assembly 42 includes one or more outlet guide vanes 43 that are stationary with respect to compressor section 14. Fluid outlet 28 is configured to channel fluid from outlet guide vane assembly 42 and/or supersonic compressor 10 to an output system 44 such as, for example, a turbine engine system, a fluid treatment system, and/or a fluid storage system. Drive assembly 18 is configured to rotate drive shaft 22 to cause a rotation of supersonic compressor rotor 40.

During operation, intake section 12 channels fluid from fluid source 34 towards compressor section 14. Compressor section 14 compresses the fluid and discharges the compressed fluid towards discharge section 16. Discharge section 16 channels the compressed fluid from compressor section 14 to output system 44 through fluid outlet 28.

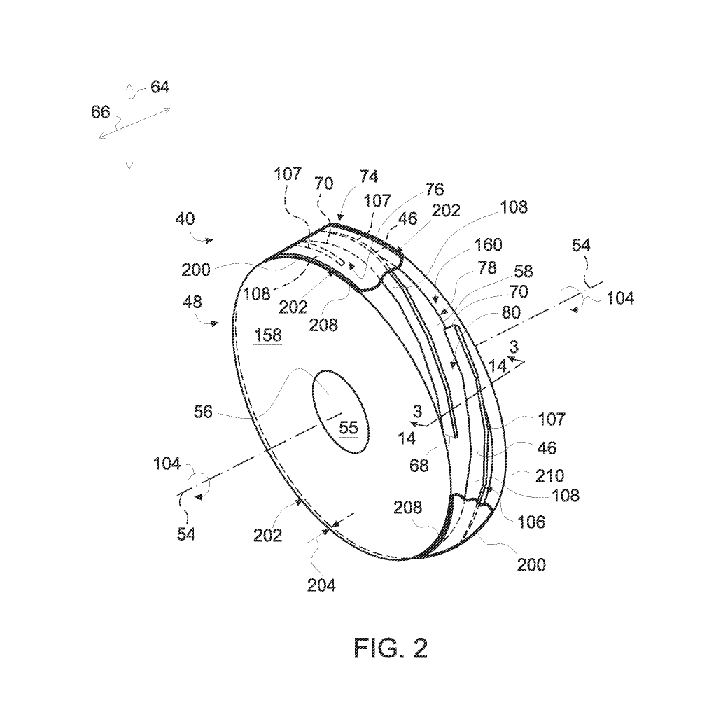

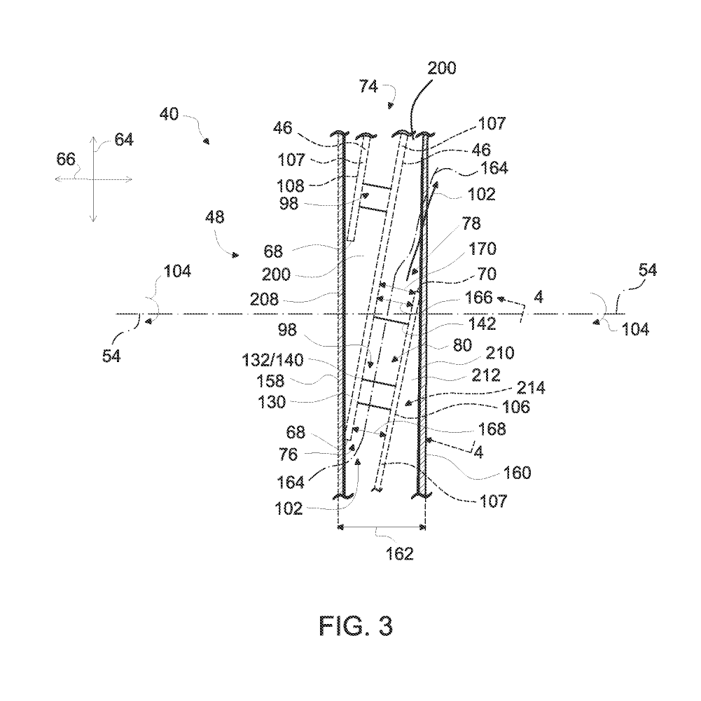

FIG. 2 is a perspective view of an exemplary supersonic compressor rotor 40 that may be used with supersonic compressor system 10 (shown in FIG. 1). FIG. 3 is an enlarged top view of a portion of supersonic compressor rotor 40 taken along line 3-3 (shown in FIG. 2). Identical components shown in FIG. 3 are labeled with the same reference numbers used in FIG. 2. In the exemplary embodiment, supersonic compressor rotor 40 includes a plurality of vanes 46 that are coupled to a rotor disk 48. Rotor disk 48 includes an annular disk body 50 that defines a centerline axis 54 and includes a radially inner surface 56 and a radially outer surface 58. Radially inner surface 56 defines a rotor cavity 55 that is substantially cylindrical in shape and is oriented about centerline axis 54. Drive shaft 22 (shown in FIG. 1) is rotatably coupled to rotor disk 48 via rotor cavity 55 through which drive shaft 22 is inserted.

Also, in the exemplary embodiment, rotor disk 48 includes an upstream surface 158, a downstream surface 160, and extends between upstream surface 158 and downstream surface 160 in axial direction 66. Each of upstream surface 158 and downstream surface 160 extends between radially inner surface 56 and radially outer surface 58. Radially outer surface 58 extends circumferentially about rotor disk 48, and between upstream surface 158 and downstream surface 160. Radially outer surface 58 has a width 162 defined in axial direction 66.

Further, in the exemplary embodiment, each vane 46 is coupled to radially outer surface 58 and extends outwardly therefrom in a radial direction 64 that is generally orthogonal to centerline axis 54. Each vane 46 is coupled to radially outer surface 58 and extends circumferentially about rotor disk 48 in a helical shape. Each vane 46 includes an inlet edge 68 and an outlet edge 70.

Moreover, in the exemplary embodiment, supersonic compressor rotor 40 includes a pair 74 of vanes 46. Each vane 46 is oriented to define an inlet opening 76, an outlet opening 78, and a fluid flow channel 80 between each pair 74 of axially adjacent vanes 46. Fluid flow channel 80 extends between inlet opening 76 and outlet opening 78 and defines a flow path, represented by arrow 164, from inlet opening 76 to outlet opening 78. Flow path 164 is oriented generally parallel to vane 46. Fluid flow channel 80 is sized, shaped, and oriented to channel fluid along flow path 164 from inlet opening 76 to outlet opening 78 in a generally axial direction 66. Inlet opening 76 is defined between adjacent inlet edges 68 of adjacent vanes 46. Outlet opening 78 is defined between adjacent outlet edges 70 of adjacent vanes 46. Each pair 74 of vanes 46 are oriented such that inlet opening 76 is defined at upstream surface 158 and outlet opening 78 is defined at downstream surface 160. Vane 46 extends circumferentially between inlet edge 68 and outlet edge 70 along radially outer surface 58 such that vane 46 extends radially outward from radially outer surface 58 in radial direction 64.

Referring to FIG. 3, in the exemplary embodiment, at least one supersonic compression ramp 98 is positioned within fluid flow channel 80. Supersonic compression ramp 98 is positioned between inlet opening 76 and outlet opening 78, and is sized, shaped, and oriented to enable one or more compression waves (not shown) to form within fluid flow channel 80.

Referring to both FIGS. 2 and 3, during operation of supersonic compressor rotor 40, intake section 12 (shown in FIG. 1) channels a fluid 102 towards inlet opening 76 of fluid flow channel 80. Fluid 102 includes a first, or approach velocity, just prior to entering inlet opening 76. Supersonic compressor rotor 40 is rotated about centerline axis 54 at a second, or rotational velocity, represented by directional arrow 104, such that fluid 102 entering fluid flow channel 80 includes a third, or inlet velocity at inlet opening 76 that is supersonic with respect to supersonic compressor rotor 40. As fluid 102 is being channeled through fluid flow channel 80 at a supersonic velocity, supersonic compression ramp 98 enables shockwaves (not shown in FIGS. 2 and 3) to form within fluid flow channel 80 to facilitate compressing fluid 102, such that fluid 102 includes an increased pressure and temperature, and/or includes a reduced volume at outlet opening 78.

In the exemplary embodiment, each vane 46 includes a pressure side 106 and an opposing suction side 108. Each pressure side 106 and suction side 108 extends between inlet edge 68 and outlet edge 70. Moreover, each vane 46 is spaced circumferentially about radially outer surface 58 such that fluid flow channel 80 is oriented generally axially between inlet opening 76 and outlet opening 78. Each inlet opening 76 extends between a pressure side 106 and an adjacent suction side 108 of vane 46 at inlet edge 68. Each outlet opening 78 extends between pressure side 106 and an adjacent suction side 108 at outlet edge 70. Moreover, each vane 46 includes a radially outermost portion 107 of each of vanes 46 extending between pressure side 106 and suction side 108.

Also, in the exemplary embodiment, fluid flow channel 80 includes a passage width 166 that is defined between pressure side 106 and adjacent suction side 108 of vanes 46 and is substantially perpendicular to axial flow path 164. Inlet opening 76 has a first passage width 168 that is larger than a second passage width 170 of outlet opening 78. Alternatively, first passage width 168 of inlet opening 76 may be less than, or equal to, second passage width 170 of outlet opening 78.

Further, in the exemplary embodiment, supersonic compressor rotor 40 includes a shroud 200 that extends about at least a portion of rotor disk 48. For purposes of clarity, shroud 200 is illustrated as transparent to facilitate showing components radially below shroud 200. Shroud 200 is coupled to a radially outermost portion 107 of each of vanes 46 and extends between upstream surface 158 and downstream surface 160 in axial direction 66. Each fluid flow channel 80 is further defined by shroud 200 in addition to pressure side 106 of a first vane 46, an opposing suction side 108 of an adjacent second vane 46, and radially outer surface 58. Supersonic compression rotor 40 also includes two annular fluid inlet passages 202. An upstream annular fluid inlet passage 202 is defined by upstream surface 158 and shroud 200. A downstream annular fluid inlet passage 202 is defined by downstream surface 160 and shroud 200. Each of inlet passages 202 defines a radial opening length 204 that has any value that enables operation of compressor rotor 40 as described herein.

In the exemplary embodiment, shroud portions 200 includes an axially upstream surface 208, an axially downstream surface 210, a radially outer surface 212, and a plurality of radially inner surfaces 214. Axially upstream surface 208 and axially downstream surface 210 are oriented generally perpendicular to axial direction arrow 66. Also, in the exemplary embodiment, radially outer surface 212 and radially inner surfaces 214 are substantially concentric with radially outer surface 58. Further, in the exemplary embodiment, radially outer surface 58 is concentrically oriented about inner surface 30 within cavity 32 (both shown in FIG. 1). Alternatively, radially outer surface 212 and radially inner surfaces 214 may be either converging or diverging with respect to radially outer surface 58 and/or inner surface 30.

Moreover, in the exemplary embodiment, shroud 200 is manufactured as a unitary piece by methods that include, without limitation, forging and casting. Alternatively, shroud 200 is fabricated from a plurality of shroud components (none shown) that are coupled to each other by fabrication methods that include, without limitation, welding and brazing.

Also, in the exemplary embodiment, axially upstream surface 208 is formed such that portions of surface 208 adjacent upstream surface 158 are aligned with surface 158 such that axially upstream surface 208 does not axially extend upstream of surface 158. Similarly, axially downstream surface 210 is formed such that portions of surface 210 adjacent downstream surface 160 are aligned with surface 160 such that axially downstream surface 210 does not axially extend downstream of surface 160.

Further, in the exemplary embodiment, radially inner surfaces 214 are the portions of shroud 200 that cooperate with pressure sides 106, suction sides 108, and radially outer surface 58 to define fluid flow channel 80.

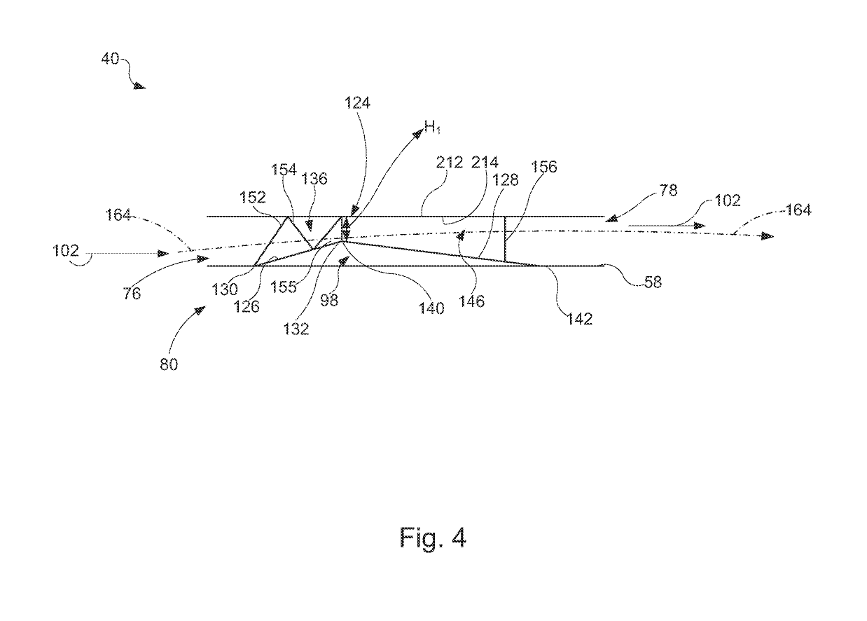

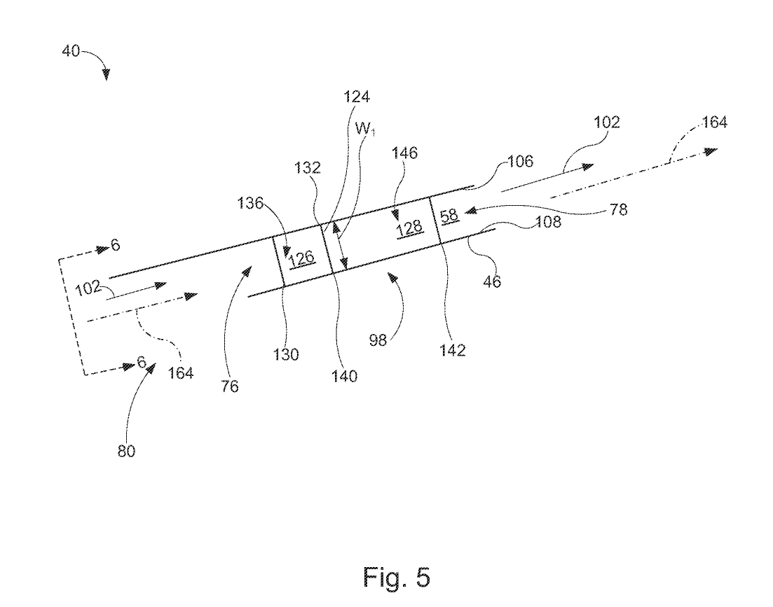

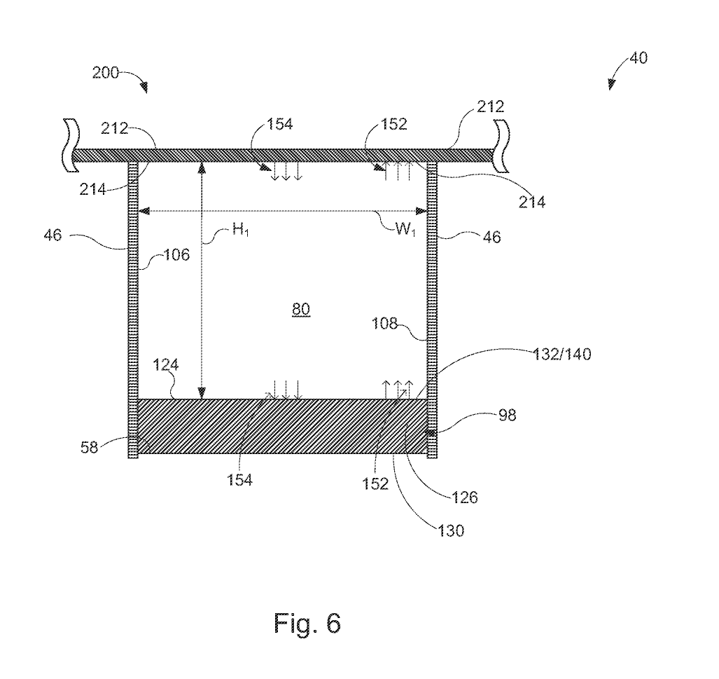

FIG. 4 is a schematic view of a portion of fluid flow channel 80 that may be used with supersonic compressor rotor 40 (shown in FIGS. 2 and 3). FIG. 5 is a top view of the portion of fluid flow channel 80. For clarity, shroud 200 is not shown in FIG. 5. FIG. 6 is a channel-wise view of the portion of fluid flow channel 80 shown in FIGS. 4 and 5 and taken along line 6-6. For purposes of clarity, FIGS. 4, 5, and 6 show fluid flow channel 80 as relatively linear, however, as shown in FIGS. 2 and 3, and described above, fluid flow channel 80 is substantially arcual as it circumscribes radially outer surface 58.

In the exemplary embodiment, a plurality of supersonic compression ramps 98 are positioned within fluid flow channel 80. FIGS. 4, 5, and 6 show a first compression ramp 98 for clarity and multiple compression ramps 98 are discussed further below. In the exemplary embodiment, compression ramp 98 is coupled to radially outer surface 58. Alternatively, compression ramp 98 is coupled to pressure side 106 of any vane 46 that defines fluid flow path 80, suction side 108 of any adjacent vane 46 that defines fluid flow channel 80, and/or radially inner surfaces 214.

Moreover, in the exemplary embodiment, supersonic compression ramp 98 includes a compression surface 126 and a diverging surface 128. Compression surface 126 includes a first, or leading edge 130 and a second, or trailing edge 132. Leading edge 130 is positioned closer to inlet opening 76 than trailing edge 132. Compression surface 126 extends between leading edge 130 and trailing edge 132 and is oriented at an oblique angle (not shown) from radially outer surface 58 into flow path 164. Compression surface 126 converges towards radially inner surfaces 214 such that a compression region 136 is defined between leading edge 130 and trailing edge 132. Compression region 136 includes a cross-sectional area (not shown) of flow channel 80 that is reduced along flow path 164 from leading edge 130 to trailing edge 132. Trailing edge 132 of compression surface 126 defines throat region 124. Throat region 124 as shown in FIGS. 4, 5, and 6 defines a first throat channel height H₁ and a first throat channel width W₁, wherein height H₁ and width W₁ are used as references for further discussion below.

Diverging surface 128 is coupled to compression surface 126 and extends downstream from compression surface 126 towards outlet opening 78. Diverging surface 128 includes a first end 140 and a second end 142 that is closer to outlet opening 78 than first end 140. First end 140 of diverging surface 128 is coupled to trailing edge 132 of compression surface 126. Diverging surface 128 extends between first end 140 and second end 142 and is oriented at an oblique angle (not shown) from second end 142 of compression surface 126 towards radially outer surface 58. Diverging surface 128 defines a diverging region 146 that includes a diverging cross-sectional area (not shown) that increases from second end 132 of compression surface 126 to outlet opening 78. Diverging region 146 extends from throat region 124 to outlet opening 78. In an alternative embodiment, supersonic compression ramp 98 does not include diverging surface 128. In this alternative embodiment, trailing edge 132 of compression surface 126 is positioned adjacent outlet edge 70 of vane 46 such that throat region 124 is defined adjacent outlet opening 78.

During operation of supersonic compressor rotor 40, fluid 102 is channeled from fluid inlet 26 (shown in FIG. 1) into inlet opening 76 at a first velocity that is supersonic with respect to rotor disk 48 (shown in FIGS. 2 and 3). Fluid 102 entering fluid flow channel 80 from fluid inlet 26 (shown in FIG. 1) contacts leading edge 130 of supersonic compression ramp 98 to form a first oblique shockwave 152. Compression region 136 of supersonic compression ramp 98 is configured to cause first oblique shockwave 152 to be oriented at an oblique angle with respect to flow path 164 from leading edge 130 towards adjacent vane 46, and into flow channel 80. As first oblique shockwave 152 contacts radially inner surfaces 214, a second oblique shockwave 154 is reflected from radially inner surfaces 214 at an oblique angle with respect to flow path 164, and towards throat region 124 of supersonic compression ramp 98. In one embodiment, compression surface 126 is oriented to cause second oblique shockwave 154 to extend from first oblique shockwave 152 at radially inner surfaces 214 to trailing edge 132 that defines throat region 124. Supersonic compression ramp 98 is configured to cause each first oblique shockwave 152 and second oblique shockwave 154 to form within compression region 136. In addition, compression ramp 98 may also be configured to cause additional shockwaves 155.

As flow channel 80 channels fluid 102 through compression region 136, a velocity of fluid 102 is reduced as fluid 102 passes through each first oblique shockwave 152 and second oblique shockwave 154. Moreover, a pressure of fluid 102 is increased, and a volume of fluid 102 is decreased as fluid 102 is channeled through compression region 136. In the exemplary embodiment, as fluid 102 is channeled through throat region 124, supersonic compression ramp 98 is configured to condition fluid 102 being channeled through compression region 136 to include a second, or outlet velocity in diverging region 146 that is supersonic with respect to rotor disk 48. Supersonic compression ramp 98 is further configured to cause a normal shockwave 156 to form downstream of throat region 124 and within flow channel 80. Normal shockwave 156 is a shockwave oriented perpendicular to flow path 164 and reduces a velocity of fluid 102 to a subsonic velocity with respect to rotor disk 48 as fluid passes through normal shockwave 156 and subsequently exits flow channel 80 via outlet opening 78.

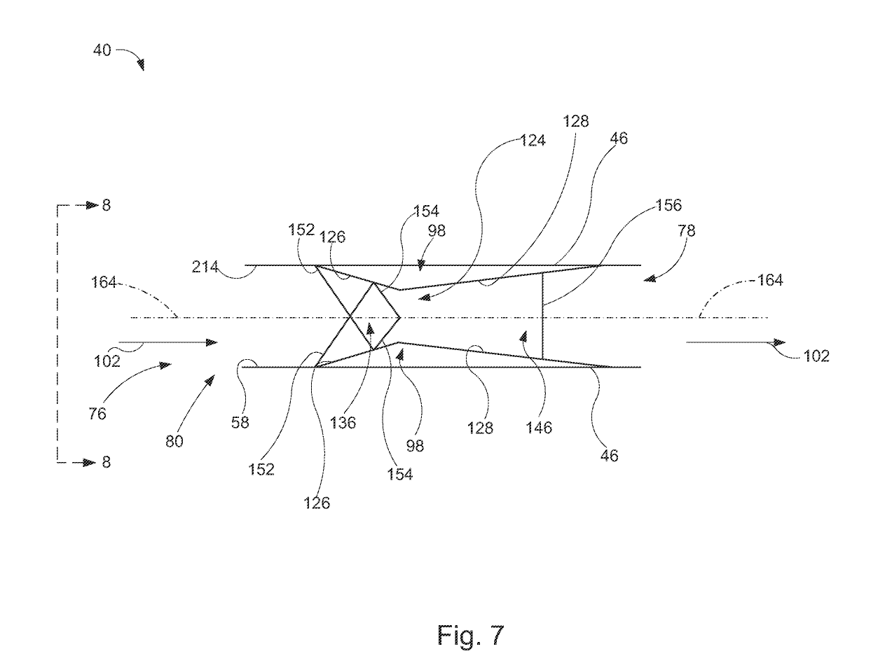

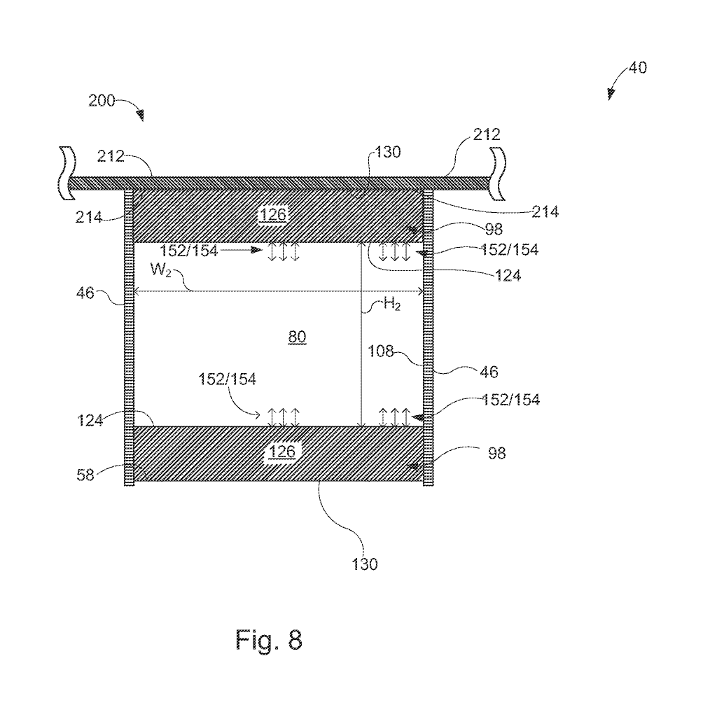

FIG. 7 is a schematic view of a portion of fluid flow channel 80 that may be used with supersonic compressor rotor 40 (shown in FIGS. 2 and 3). FIG. 8 is a channel-wise view of the portion of fluid flow channel 80 taken along line 8-8 (shown in FIG. 7). As described above, FIGS. 7 and 8 show fluid flow channel 80 as relatively linear, however, fluid flow channel 80 is substantially arcual as it circumscribes radially outer surface 58.

In the exemplary embodiment, as shown in FIGS. 7 and 8, a pair of opposing supersonic compression ramps 98 are positioned within fluid flow channel 80. A first compression ramp 98 is coupled to radially outer surface 58 as described above and a second, opposing compression ramp 98 is coupled to radially inner surfaces 214. Alternatively, opposing compression ramps 98 are coupled to pressure side 106 of a vane 46 that defines fluid flow path 80 and an opposing suction side 108 of an adjacent vane 46 that defines fluid flow channel 80.

Compression ramps 98 are substantially similar and cooperate to define a throat region 124 that, as shown in FIGS. 7 and 8, defines a second throat channel height H₂ and a second throat channel width W₂, wherein height H₂ is less than height H₁ (shown in FIGS. 4 and 6) and width W₂ is substantially similar to width W₁ (shown in FIGS. 5 and 6). Such configuration with height H₂ and width W₂ facilitates increased pressures within fluid flow channel 80 as compared to the configuration with height H₁ and width W₁. However, such smaller dimensions may restrict fluid flow rates therethrough, and a predetermined balance between fluid pressurization and fluid throughput is established. Alternatively, height H₂ is equal to or greater than height H₁ and width W₂ is equal to or greater than width W₁, thereby also establishing a predetermined balance between fluid pressurization and fluid throughput. Therefore, height H₂ and width W₂ have any values that enable operation of supersonic compressor rotor 40 as described herein.

Alternative embodiments may include axially opposing supersonic compression ramps 98, wherein a first supersonic compression ramp 98 is coupled to pressure side 106 of a first vane 46 and a second supersonic compression ramp 98 is coupled to opposing suction side 108 of a second adjacent vane 46.

During operation of supersonic compressor rotor 40 and fluid flow channel 80 with two opposing supersonic compression ramps 98, fluid 102 is channeled from fluid inlet 26 (shown in FIG. 1) into inlet opening 76 at a first velocity that is supersonic with respect to rotor disk 48 (shown in FIGS. 2 and 3). Fluid 102 entering fluid flow channel 80 from fluid inlet 26 (shown in FIG. 1) contacts each opposing leading edge 130 of both opposing supersonic compression ramps 98 to form first opposing oblique shockwaves 152, such opposing shockwaves 152 substantially reflect off of each other as described further below. As each first oblique shockwave 152 contacts opposing compression surfaces 126, a pair of opposing second oblique shockwaves 154 are reflected from opposing compression surfaces 126 towards the opposing supersonic compression ramp 98. As described further below, second oblique shockwaves 154 are attenuated as compared to embodiments with only one supersonic compression ramp 98, as described above.

As fluid flow channel 80 channels fluid 102 through compression region 136, a velocity of fluid 102 is reduced as fluid 102 passes through each opposing first oblique shockwave 152 and second oblique shockwave 154. Moreover, a pressure of fluid 102 is increased, and a volume of fluid 102 is decreased as fluid 102 is channeled through compression region 136. In the exemplary embodiment, as fluid 102 is channeled through throat region 124, opposing supersonic compression ramps 98 are configured to condition fluid 102 being channeled through compression region 136 to include a second, or outlet velocity in diverging region 146 that is supersonic with respect to rotor disk 48. Opposing supersonic compression ramps 98 are further configured to cooperate to cause a normal shockwave 156 to form downstream of throat region 124 and within flow channel 80. Normal shockwave 156 reduces a velocity of fluid 102 to a subsonic velocity with respect to rotor disk 48 as fluid passes through normal shockwave 156 and subsequently exits flow channel 80 via outlet opening 78.

In general, opposing shockwaves interact with each other to decrease internal parasitic losses within the compression cycle due to the flow field distortion resulting from boundary layers and shock boundary layer interactions. Such losses due to shock-boundary layer interaction may be significant. Moreover, in addition to the aforementioned losses, an effective cross-sectional area of the fluid flow channel used for supersonic compression is effectively decreased due to shock-boundary layer interaction and flow separation. In the exemplary embodiment, opposing supersonic compression ramps 98 form a pair of first opposing oblique shockwaves 152 and a pair of reflected, opposing second oblique shockwaves 154. That is, two oblique shocks, instead of one are generated and they reflect from each other instead of reflecting from opposing surfaces. Such interaction between opposing shockwaves significantly reduces shock reflection from the opposing surfaces, thereby significantly reducing associated shock-boundary layer interaction and boundary layer losses thereof. Therefore, use of opposing shockwaves as described herein effectively reduces such parasitic losses induced by opposing surface interactions with the shockwaves, thereby increasing an effective flow area within the supersonic compressor rotor's fluid flow channel. Moreover, decreasing such losses increases an efficiency of the supersonic compressor, thereby increasing a flow capacity and a pressurization ratio of the supersonic compressor, and thereby decreasing a value of compressor footprint per unit flow volume.

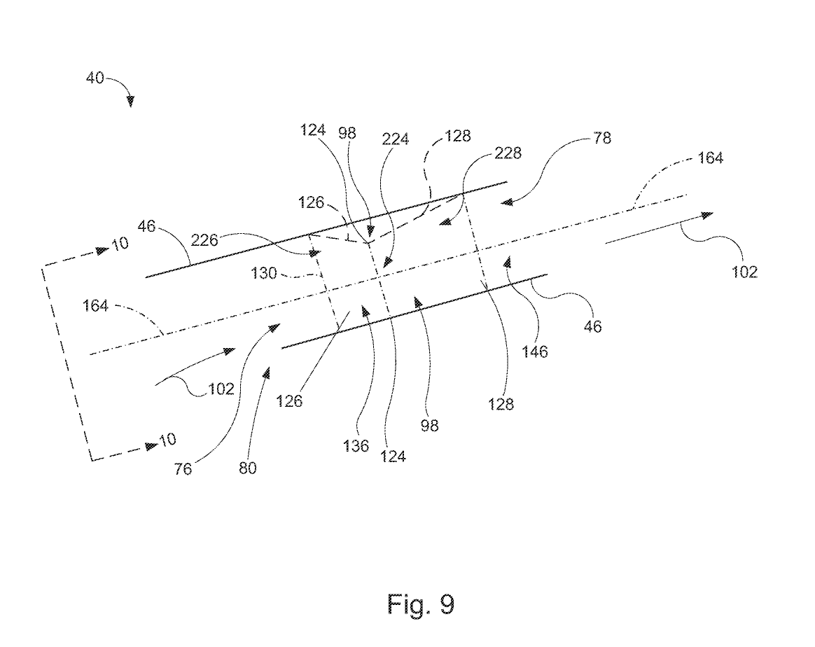

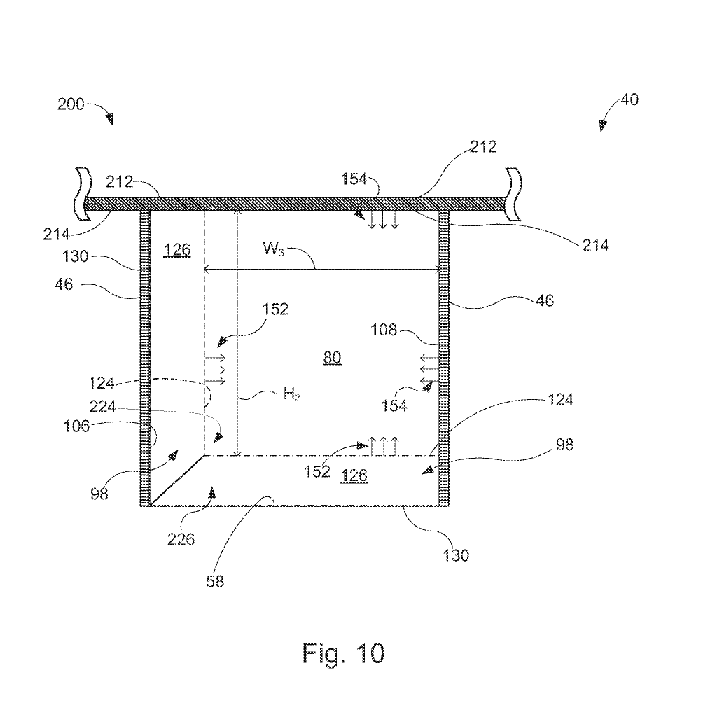

FIG. 9 is a schematic view of a portion of fluid flow channel 80 that may be used with supersonic compressor rotor 40 (shown in FIGS. 2 and 3). FIG. 10 is a channel-wise view of the portion of fluid flow channel 80 taken along line 10-10 (shown in FIG. 9). As described above, FIGS. 9 and 10 show fluid flow channel 80 as relatively linear, however, fluid flow channel 80 is substantially arcual as it circumscribes radially outer surface 58.

In the exemplary embodiment, a plurality of supersonic compression ramps 98 are positioned within fluid flow channel 80. FIGS. 9 and 10 show adjacent compression ramps 98. A first compression ramp 98 is coupled to radially outer surface 58 as described above. Moreover, in the exemplary embodiment, a second, adjacent compression ramp 98 is coupled to pressure side 106 of a vane 46 and radially inner surface 214 of shroud 200, thereby defining fluid flow channel 80. Each of compression ramps 98 are substantially similar. Adjacent compression surfaces 126 form a two-sided compression surface 226. Similarly, adjacent diverging surfaces 128 form a two-sided divergent surface 228. Further, adjacent throat regions 124 define a two-sided throat region 224.

Also, in the exemplary embodiment, and as shown in FIGS. 9 and 10, throat region 224 defines a third throat channel height H₃ and a third throat channel width W₃, wherein height H₃ is less than height H₁ (shown in FIGS. 4 and 6) and width W₃ is less than width W₁ (shown in FIGS. 5 and 6). In a manner similar to that described for the opposing ramp embodiment shown in FIGS. 7 and 8, use of adjacent supersonic compression ramps 98 with height H₃ and width W₃ facilitates increased pressures within fluid flow channel 80 as compared to the configuration with height H₁ and width W₁. However, such smaller dimensions may restrict fluid flow rates therethrough, and a predetermined balance between fluid pressurization and fluid throughput is established. Alternatively, height H₃ is equal to or greater than height H₁ and width W₃ is equal to or greater than width W₁, thereby also establishing a predetermined balance between fluid pressurization and fluid throughput. Therefore, height H₃ and width W₃ have any values that enable operation of supersonic compressor rotor 40 as described herein.

During operation of supersonic compressor rotor 40 and fluid flow channel 80 with two adjacent supersonic compression ramps 98, fluid 102 is channeled from fluid inlet 26 (shown in FIG. 1) into inlet opening 76 at a first velocity that is supersonic with respect to rotor disk 48 (shown in FIGS. 2 and 3). Fluid 102 entering fluid flow channel 80 from fluid inlet 26 (shown in FIG. 1) contacts each adjacent leading edge 130 of both adjacent supersonic compression ramps 98 to form first adjacent oblique shockwaves 152, such adjacent shockwaves 152 substantially passing through each other as described further below. As each first oblique shockwave 152 contacts radially inner surfaces 214 and suction side 108 of a vane 46 that defines fluid flow channel 80, a pair of adjacent second oblique shockwaves 154 are reflected from radially inner surfaces 214 and suction side 108 towards each respective supersonic compression ramp 98. As described further below, the second oblique shockwaves 154 associated with adjacent supersonic compression ramps 98 are attenuated as compared to embodiments with only one supersonic compression ramp 98, as described above.

As fluid flow channel 80 channels fluid 102 through compression region 136, a velocity of fluid 102 is reduced as fluid 102 passes through each opposing first oblique shockwave 152 and second oblique shockwave 154. Moreover, a pressure of fluid 102 is increased, and a volume of fluid 102 is decreased as fluid 102 is channeled through compression region 136. In the exemplary embodiment, as fluid 102 is channeled through throat region 224, adjacent supersonic compression ramps 98 are configured to condition fluid 102 being channeled through compression region 136 to include a second, or outlet velocity in diverging region 146 that is supersonic with respect to rotor disk 48. Adjacent supersonic compression ramps 98 are further configured to cooperate to cause a normal shockwave (not shown in FIGS. 9 and 10) to form downstream of throat region 224 and within flow channel 80. The normal shockwave reduces a velocity of fluid 102 to a subsonic velocity with respect to rotor disk 48 as fluid passes through the normal shockwave and subsequently exits flow channel 80 via outlet opening 78.

As described above for opposing shockwaves, in general, adjacent shockwaves interact with each other to decrease internal parasitic losses within the compression cycle due to the flow field distortion resulting from boundary layers and shock boundary layer interactions. In the exemplary embodiment, adjacent supersonic compression ramps 98 form a pair of first adjacent oblique shockwaves 152 and a pair of reflected, adjacent second oblique shockwaves 154. That is, two oblique shocks, instead of one are generated and they reflect from each other instead of reflecting from opposing surfaces. Such interaction between adjacent shockwaves significantly reduces shock reflection from the opposing surfaces, thereby significantly reducing associated shock-boundary layer interaction and boundary layer losses thereof. Therefore, use of adjacent shockwaves as described herein effectively reduces such parasitic losses induced by opposing surface interactions with the shockwaves, thereby increasing an effective flow area within the supersonic compressor rotor's fluid flow channel. Moreover, decreasing such losses increases an efficiency of the supersonic compressor, thereby increasing a flow capacity and a pressurization ratio of the supersonic compressor, and thereby decreasing a value of compressor footprint per unit flow volume.

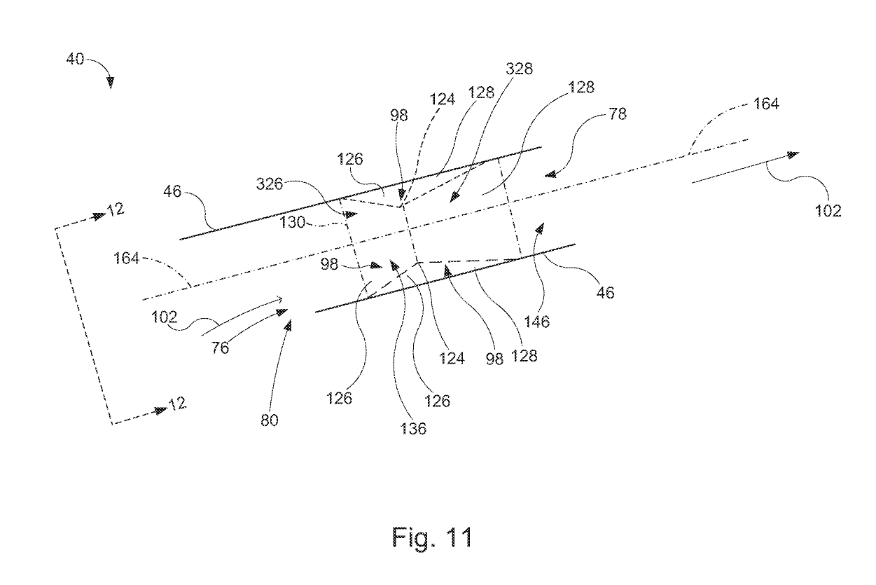

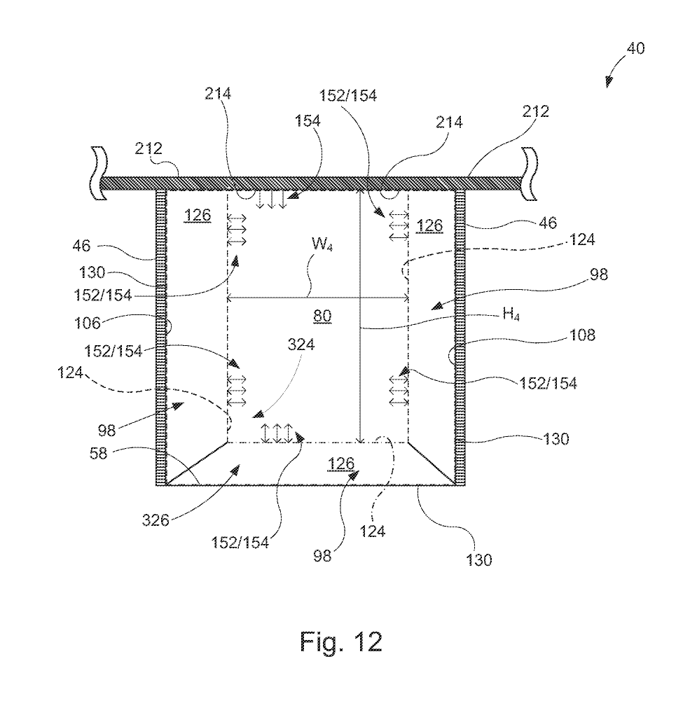

FIG. 11 is a schematic view of a portion of fluid flow channel 80 that may be used with supersonic compressor rotor 40 (shown in FIGS. 2 and 3). FIG. 12 is a channel-wise view of the portion of fluid flow channel 80 taken along line 12-12 (shown in FIG. 11). As described above, FIGS. 11 and 12 show fluid flow channel 80 as relatively linear, however, fluid flow channel 80 is substantially arcual as it circumscribes radially outer surface 58.

In the exemplary embodiment, a plurality of supersonic compression ramps 98 are positioned within fluid flow channel 80. FIGS. 11 and 12 show three supersonic compression ramps 98, wherein there are two opposing supersonic compression ramps 98 and a third compression ramp 98 that contacts each of the opposing compression ramps 98. A first compression ramp 98 is coupled to radially outer surface 58. Moreover, in the exemplary embodiment, a second compression ramp 98 is coupled to pressure side 106 of a vane 46 and radially inner surface 214 of shroud 200, thereby partially defining fluid flow channel 80. Further, in the exemplary embodiment, a third compression ramp 98 is coupled to suction side 108 of a vane 46 and radially inner surface 214 of shroud 200, thereby further defining fluid flow channel 80. First and second pressure ramps 98 are adjacent, first and third pressure ramps 98 are adjacent, and second and third pressure ramps 98 are opposing. The plurality of compression surfaces 126 form a three-sided compression surface 326. Similarly, the plurality of diverging surfaces 128 form a three-sided divergent surface 328. Further, the plurality of throat regions 124 define a three-sided throat region 324.

Also, in the exemplary embodiment, and as shown in FIGS. 11 and 12, throat region 324 defines a fourth throat channel height H₄ and a fourth throat channel width W₄, wherein height H₄ is less than height H₁ (shown in FIGS. 4 and 6) and width W₄ is less than width W₁ (shown in FIGS. 5 and 6). In a manner similar to that described for the opposing ramp embodiment shown in FIGS. 7 and 8 and adjacent ramp embodiment shown in FIGS. 9 and 10, use of adjacent and opposing supersonic compression ramps 98 facilitates increasing pressures within fluid flow channel 80 as compared to the configuration with height H₁ and width W₁. However, such smaller dimensions may restrict fluid flow rates therethrough, and a predetermined balance between fluid pressurization and fluid throughput is established. Alternatively, height H₄ is equal to or greater than height H₁ and width W₄ is equal to or greater than width W₁, thereby also establishing a predetermined balance between fluid pressurization and fluid throughput. Therefore, height H₄ and width W₄ have any values that enable operation of supersonic compressor rotor 40 as described herein.

During operation of supersonic compressor rotor 40 and fluid flow channel 80 with three supersonic compression ramps 98, fluid 102 is channeled from fluid inlet 26 (shown in FIG. 1) into inlet opening 76 at a first velocity that is supersonic with respect to rotor disk 48 (shown in FIGS. 2 and 3). Fluid 102 entering fluid flow channel 80 from fluid inlet 26 (shown in FIG. 1) contacts each adjacent leading edge 130 of the three supersonic compression ramps 98 to form first adjacent oblique shockwaves 152. Such adjacent shockwaves 152 substantially pass through each other as described further below. As each first oblique shockwave 152 contacts an opposing supersonic compression ramp 98 and/or radially inner surfaces 214, three second oblique shockwaves 154 are reflected from radially inner surfaces 214 and opposing supersonic compression ramp 98 towards each respective supersonic compression ramp 98. As described further below, the second oblique shockwaves 154 associated with the three supersonic compression ramps 98 are attenuated as compared to embodiments with only one supersonic compression ramp 98, as described above.

As fluid flow channel 80 channels fluid 102 through compression region 136, a velocity of fluid 102 is reduced as fluid 102 passes through each first oblique shockwave 152 and second oblique shockwave 154. Moreover, a pressure of fluid 102 is increased, and a volume of fluid 102 is decreased as fluid 102 passes through compression region 136. In the exemplary embodiment, as fluid 102 passes through throat region 324, supersonic compression ramps 98 are configured to condition fluid 102 passing through compression region 136 to include a second, or outlet velocity in diverging region 146 that is supersonic with respect to rotor disk 48. Supersonic compression ramps 98 are further configured to cooperate to cause a normal shockwave (not shown in FIGS. 11 and 12) to form downstream of throat region 324 and within flow channel 80. The normal shockwave reduces a velocity of fluid 102 to a subsonic velocity with respect to rotor disk 48 as fluid passes through the normal shockwave and subsequently exits flow channel 80 via outlet opening 78.

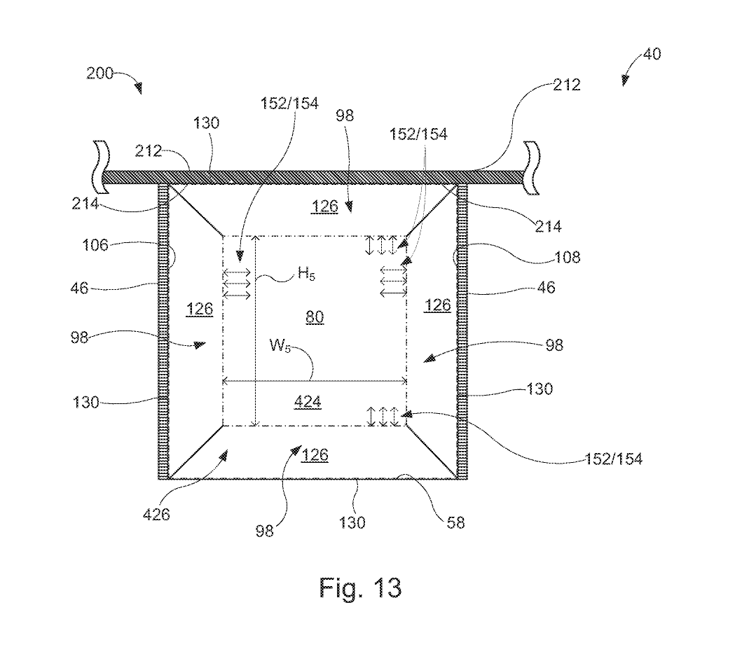

FIG. 13 is a channel-wise view of the portion of fluid flow channel 80. In the exemplary embodiment, four supersonic compression ramps 98 are positioned within fluid flow channel 80. A first compression ramp 98 is coupled to radially outer surface 58, a second compression ramp 98 is coupled to pressure side 106 of a vane 46 defining fluid flow channel 80, a third compression ramp 98 is coupled to suction side 108 of a vane 46 defining fluid flow channel 80, and a fourth compression ramp 98 is coupled to radially inner surfaces 214. The four supersonic compression ramps 98 are each adjacent and opposite to other supersonic compression ramps 98.

Each compression ramp 98 is substantially similar. The plurality of compression surfaces 126 form a four-sided compression surface 426. Similarly, the plurality of diverging surfaces 128 form a four-sided divergent surface (not shown). Further, the plurality of throat regions 124 define a four-sided throat region 424. Throat region 424 defines a fifth throat channel height H₅ and a fifth throat channel width W₅, wherein height H₅ is less than height H₁ (shown in FIGS. 4 and 6) and width W₅ is less than width W₁ (shown in FIGS. 5 and 6). In a manner similar to that described for the opposing ramp embodiment shown in FIGS. 7 and 8 and adjacent ramp embodiment shown in FIGS. 9 and 10, use of adjacent and opposing supersonic compression ramps 98 facilitates increased pressures within fluid flow channel 80 as compared to the configuration with height H₁ and width W₁. However, such smaller dimensions may restrict fluid flow rates therethrough, and a predetermined balance between fluid pressurization and fluid throughput is established. Alternatively, height H₅ is equal to or greater than height H₁ and width W₅ is equal to or greater than width W₁, thereby also establishing a predetermined balance between fluid pressurization and fluid throughput. Therefore, height H₅ and width W₅ have any values that enable operation of supersonic compressor rotor 40 as described herein.

During operation of supersonic compressor rotor 40 and fluid flow channel 80 with three supersonic compression ramps 98, fluid 102 is channeled from fluid inlet 26 (shown in FIG. 1) into inlet opening 76 (shown in FIGS. 2 and 3) at a first velocity that is supersonic with respect to rotor disk 48 (shown in FIGS. 2 and 3). Fluid 102 entering fluid flow channel 80 from fluid inlet 26 (shown in FIG. 1) contacts each adjacent leading edge 130 of the four supersonic compression ramps 98 to form first adjacent oblique shockwaves 152, such adjacent shockwaves 152 substantially passing through each other as described further below. As each first oblique shockwave 152 contacts an opposing supersonic compression ramp 98, four second oblique shockwaves 154 are reflected from opposing supersonic compression ramp 98 towards each respective supersonic compression ramp 98. As described above, the second oblique shockwaves 154 associated with the three supersonic compression ramps 98 are attenuated as compared to embodiments with only one supersonic compression ramp 98, as described above.

As fluid flow channel 80 channels fluid 102 through compression region 136, a velocity of fluid 102 (shown in FIG. 3) is reduced as fluid 102 passes through each first oblique shockwave 152 and second oblique shockwave 154. Moreover, a pressure of fluid 102 is increased, and a volume of fluid 102 is decreased as fluid 102 is channeled through compression region 136 (shown in FIG. 4). In the exemplary embodiment, as fluid 102 is channeled through throat region 424, supersonic compression ramps 98 are configured to condition fluid 102 being channeled through compression region 136 to include a second, or outlet velocity in diverging region 146 (shown in FIG. 4) that is supersonic with respect to rotor disk 48 (shown in FIGS. 2 and 3). Supersonic compression ramps 98 are further configured to cooperate to cause a normal shockwave (not shown in FIG. 13) to form downstream of throat region 424 and within flow channel 80. The normal shockwave reduces a velocity of fluid 102 to a subsonic velocity with respect to rotor disk 48 as fluid passes through the normal shockwave and subsequently exits flow channel 80 via outlet opening 78.

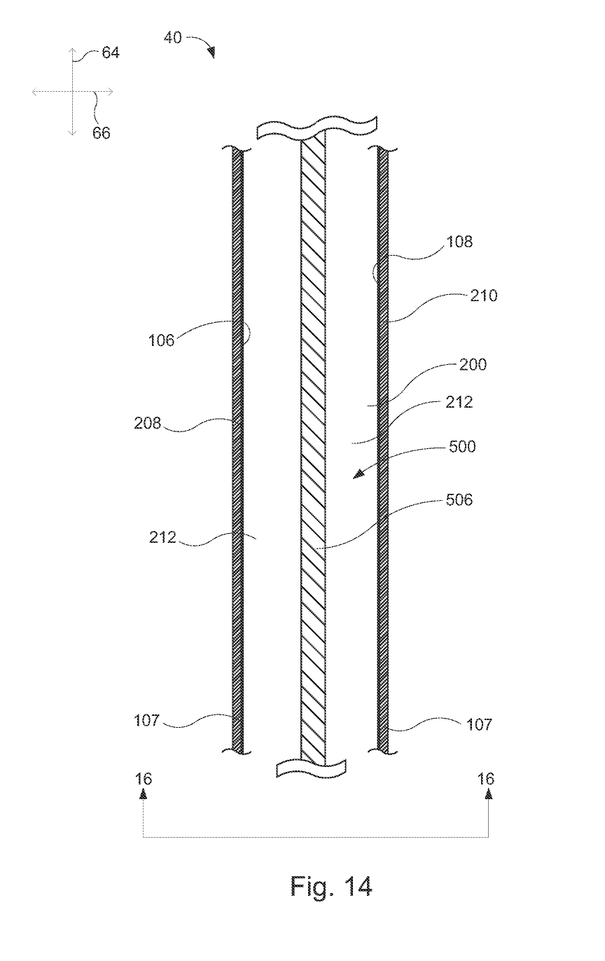

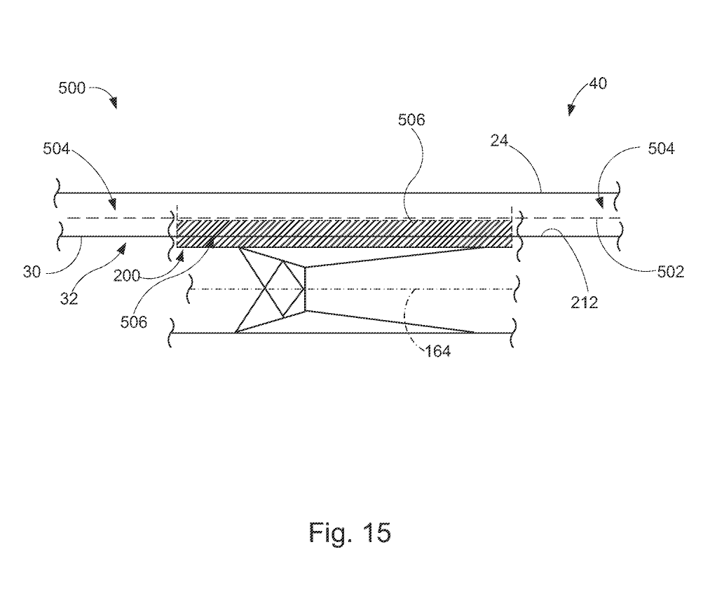

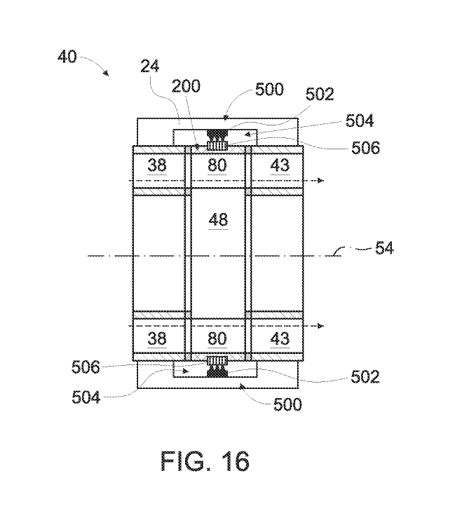

FIG. 14 is an enlarged top view of a portion of supersonic compressor rotor 40 taken along line 14-14 (shown in FIG. 2). FIG. 15 is a schematic view of a portion of supersonic compressor rotor 40 shown in FIG. 14. FIG. 16 is a schematic view of the portion of supersonic compressor rotor 40 taken along line 16-16 (shown in FIG. 14). In the exemplary embodiment, shroud 200 is positioned between pressure side 106 of a vane 46 and suction side 108 of an adjacent vane 46. In the exemplary embodiment, at least a portion of an axial sealing mechanism 500 is positioned on radially outer surface 212 of shroud 200. Sealing mechanism 500 is any sealing mechanism that enables operation of supersonic compression system 10 (shown in FIG. 1) as described herein including, without limitation, labyrinth teeth-type devices and brush-type devices.

Sealing mechanism 500 includes a plurality of radially inner portions of labyrinth teeth 502 that define at least one channel 504 therebetween within compressor housing 24. Sealing mechanism 500 also includes a sealing strip 506 coupled to radially outer surface 212 of shroud 200 by any method that enables operation of sealing mechanism 500 as described herein, including, without limitation, adhesives, fastening hardware, and insertion into a channel defined within shroud 200 (neither shown). Alternative embodiments of sealing mechanism 500 include using a brush strip rather than sealing strip 506, teeth 502, and channel 504, wherein the brush strip is coupled to radially outer surface 212 of shroud 200 as described above for sealing strip 506, and the brush strip is positioned, oriented, and configured to gently contact inner surface 30 of compressor housing 24.

In general, fluid leakage across radially outermost portion 107 of each of vanes 46 is one of the principal sources of efficiency loss for supersonic compressors, especially due to the large pressure gradients spanning vanes 46. Shroud 200 facilitates a reduction in such fluid leakage. Moreover, sealing mechanism 500 facilitates a reduction in fluid flow losses within housing cavity 32 by decreasing a size of potential fluid flow paths between shroud 200 and inner housing surface 30 to those tolerances between teeth 502 and strip 506. Moreover, increasing the number of seals 506 and teeth 502 facilitates forming a more tortuous flow path, thereby further decreasing a potential for fluid flow losses therein.

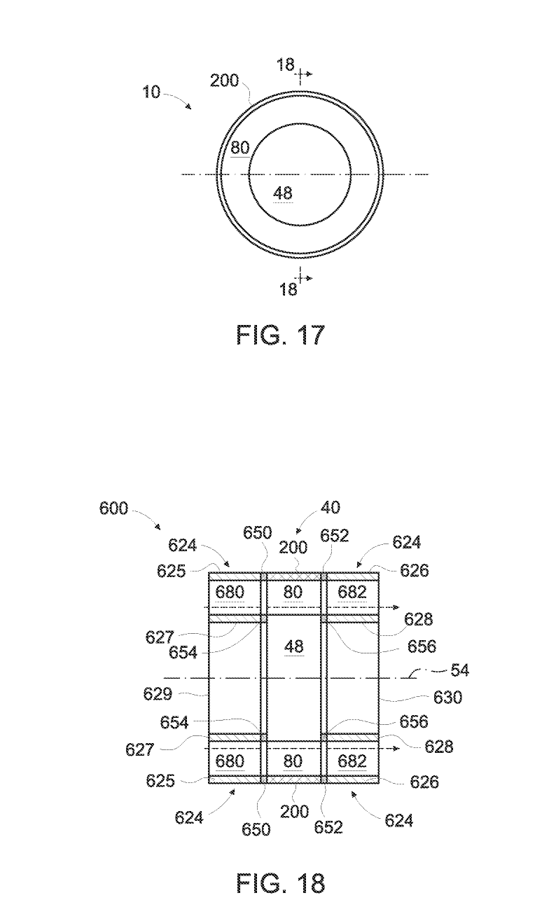

FIG. 17 is a schematic view of a portion of an alternative supersonic compressor system 600. FIG. 18 is a schematic view of the portion of supersonic compressor system 600 taken along line 18-18 (shown in FIG. 16). In this alternative exemplary embodiment, system 600 includes supersonic compressor rotor 40 as described above, including, without limitation, fluid flow channel 80 defined between rotor disk 48 and shroud 200. Also, in this alternative embodiment, supersonic compressor system 600 includes a compressor housing 624 that is similar to compressor housing 24 (shown in FIG. 1) with the exception that housing 624 includes a radially outer upstream housing portion 625, a radially outer downstream housing portion 626, a radially inner upstream housing portion 627, and a radially inner downstream housing portion 628. Housing portions 625 and 627 define an upstream fluid flow channel 480 and housing portions 626 and 628 define a downstream fluid flow channel 482. Fluid flow channels 680, 80, and 682 are coupled in fluid communication. Radially inner upstream housing portion 627 and rotor disk 48 define an upstream gap 629 and radially inner downstream housing portion 628 and rotor disk 48 define a downstream gap 630. Further, in this alternative exemplary embodiment, shroud 200 is axially positioned between housing portions 625 and 626. Further, in this alternative embodiment, shroud 200 is substantially radially flush with housing portions 625 and 626. Alternatively, shroud 200 extends radially inward within, or radially outward beyond, housing 624.

In this alternative exemplary embodiment, supersonic compressor system includes a plurality of substantially circular, radial seals 650, 652, 654, and 656. Seal 650 is circumferentially positioned between radially outer upstream housing portion 625 and shroud 200 and facilitates a decrease in fluid flow from fluid flow channels 680 and 80 to an environment outside of housing 624. Seal 652 is circumferentially positioned between radially outer downstream housing portion 626 and shroud 200 and facilitates a decrease in fluid flow from fluid flow channels 80 and 682 to the environment outside of housing 624. Seal 654 is circumferentially positioned between radially inner upstream housing portion 627 and rotor disk 48 and facilitates a decrease in fluid flow from fluid flow channels 680 and 80 into gap 629. Seal 656 is circumferentially positioned between radially inner downstream housing portion 628 and rotor disk 48 and facilitates a decrease in fluid flow from fluid flow channels 80 and 682 into gap 630.

In this alternative exemplary embodiment, in operation, shroud 200 rotates about seals 650, 652, 654, and 656 at relatively high rotational speeds as described above. Therefore, seals 650, 652, 654, and 656 are operatively coupled to shroud 200 and rotor disk 48 and include any sealing devices that enable operation of supersonic compressor system 600 as described herein. Moreover, in this alternative exemplary embodiment, four radial seals are used within supersonic compressor system 600. Alternatively, any number of radial seals that enable operation of supersonic compressor system 600 as described herein are used.

The above-described supersonic compressor rotor provides a cost effective and reliable method for increasing an efficiency of performance of supersonic compressor systems during all phases of fluid compression operations. Moreover, the supersonic compressor rotor facilitates increasing the operating efficiency of the supersonic compressor system by reducing fluid flow losses across the radially outer portions of the vanes. More specifically, the supersonic compressor rotor includes a shroud positioned over the radially outer tops of the vanes, thereby separating the plurality of fluid flow paths defined by adjacent vanes. Also, more specifically, the above-described supersonic compressor rotor includes sealing mechanisms positioned axially or radially between the shroud and the rotor housing to reduce flow losses within the rotor housing.

Exemplary embodiments of systems and methods for assembling and operating a supersonic compressor rotor are described above in detail. The systems and methods are not limited to the specific embodiments described herein, but rather, components of systems and/or steps of the method may be utilized independently and separately from other components and/or steps described herein. For example, the systems and methods may also be used in combination with other rotary engine systems and methods, and are not limited to practice with only the supersonic compressor system as described herein. Rather, the exemplary embodiment can be implemented and utilized in connection with many other rotary system applications.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A supersonic compressor comprising:
a fluid inlet;
a fluid outlet;
a fluid conduit extending between said fluid inlet and said fluid outlet;
at least one supersonic compressor rotor disposed within said fluid conduit of said supersonic compressor comprising:
at least one rotor disk comprising a substantially cylindrical body extending between a radially inner surface and a radially outer surface;
a plurality of vanes coupled to said body, said vanes extending radially outward from said at least one rotor disk, adjacent said vanes forming a pair;
a shroud extending about at least a portion of said at least one rotor disk, said shroud coupled to at least a portion of each of said plurality of vanes, wherein said radially outer surface, said pair of adjacent vanes, and said shroud are oriented such that a fluid flow channel is defined therebetween, said fluid flow channel comprises a fluid inlet opening and a fluid outlet opening; and
a plurality of adjacent supersonic compression ramps positioned within said fluid flow channel, each of said plurality of adjacent supersonic compression ramps configured to condition a fluid being channeled through said fluid flow channel such that the fluid is characterized by a first velocity at said inlet opening and a second velocity at said outlet opening, said first velocity being supersonic with respect to said rotor disk surfaces; and
a casing extending about at least a portion of said shroud.

2. The supersonic compressor according to claim 1, wherein said plurality of adjacent supersonic compression ramps comprise at least one of:
two adjacent ramps;
three adjacent ramps; and
four adjacent ramps.

3. The supersonic compressor according to claim 1, wherein said plurality of adjacent supersonic compression ramps comprise:
at least one axial compression ramp coupled to at least one radial compression ramp;
at least one axial throat portion coupled to at least one radial throat portion; and
at least one axial diverging portion coupled to at least one radial diverging portion.

4. The supersonic compressor according to claim 1, wherein said plurality of adjacent supersonic compression ramps are configured to form:
a plurality of axial oblique shockwaves; and
a plurality of radial oblique shock waves.

5. The supersonic compressor according to claim 1, wherein said shroud comprises at least one sealing mechanism coupled thereto.

6. The supersonic compressor according to claim 5, wherein said at least one sealing mechanism comprises at least one of:
at least one axial seal; and
at least one radial seal.

7. The supersonic compressor according to claim 5, wherein said at least one radial seal extends radially between at least one of:
said casing and said shroud; and
said casing and said at least one rotor disk.

8. The supersonic compressor according to claim 1, wherein at least a portion of one of said plurality of supersonic compression ramps is coupled to said shroud.

9. A supersonic compressor rotor comprising:
at least one rotor disk comprising a substantially cylindrical body extending between a radially inner surface and a radially outer surface;
a plurality of vanes coupled to said body, said vanes extending radially outward from said at least one rotor disk, adjacent said vanes forming a pair;
a shroud extending about at least a portion of said at least one rotor disk, said shroud coupled to at least a portion of each of said plurality of vanes, wherein said radially outer surface, said pair of adjacent vanes, and said shroud are oriented such that a fluid flow channel is defined therebetween, said fluid flow channel comprises a fluid inlet opening and a fluid outlet opening; and
a plurality of adjacent supersonic compression ramps positioned within said fluid flow channel, each of said plurality of adjacent supersonic compression ramps configured to condition a fluid being channeled through said fluid flow channel such that the fluid is characterized by a first velocity at said inlet opening and a second velocity at said outlet opening, said first velocity being supersonic with respect to said rotor disk surfaces.

10. The supersonic compressor rotor according to claim 9, wherein said plurality of adjacent supersonic compression ramps comprise at least one of:
two adjacent ramps;
three adjacent ramps; and
four adjacent ramps.

11. The supersonic compressor rotor according to claim 9, wherein said plurality of adjacent supersonic compression ramps comprise:
at least one axial compression ramp coupled to at least one radial compression ramp;
at least one axial throat portion coupled to at least one radial throat portion; and
at least one axial diverging portion coupled to at least one radial diverging portion.

12. The supersonic compressor rotor according to claim 9, wherein said plurality of adjacent supersonic compression ramps are configured to form:
a plurality of axial oblique shockwaves; and
a plurality of radial oblique shock waves.

13. The supersonic compressor rotor according to claim 9, wherein said shroud comprises at least one sealing mechanism coupled thereto.

14. The supersonic compressor startup support system according to claim 13, wherein said at least one sealing mechanism comprises at least one of:
at least one axial seal; and
at least one radial seal.

15. The supersonic compressor rotor according to claim 9, wherein at least a portion of one of said plurality of supersonic compression ramps is coupled to said shroud.

16. A method for assembling a supersonic compressor, said method comprising:
providing a casing that defines a fluid inlet, a fluid outlet, and a fluid conduit extending therebetween; and
disposing at least one supersonic compressor rotor within the fluid conduit of the supersonic compressor comprising:
providing at least one rotor disk comprising a substantially cylindrical body extending between a radially inner surface and a radially outer surface;
coupling a plurality of vanes to the body, the vanes extending radially outward from the at least one rotor disk, adjacent the vanes forming a pair;
coupling a shroud to at least a portion of each of the plurality of vanes and extending the shroud about at least a portion of the at least one rotor disk, wherein the casing extends about at least a portion of the shroud;
orienting the radially outer surface, the pair of adjacent vanes, and the shroud such that a fluid flow channel is defined therebetween, the fluid flow channel comprises a fluid inlet opening and a fluid outlet opening; and
positioning a plurality of adjacent supersonic compression ramps within the fluid flow channel, each of the plurality of adjacent supersonic compression ramps configured to condition a fluid being channeled through the fluid flow channel such that the fluid is characterized by a first velocity at the inlet opening and a second velocity at the outlet opening, the first velocity being supersonic with respect to the rotor disk surfaces.

17. The method according to claim 16, wherein positioning a plurality of adjacent supersonic compression ramps within the fluid flow channel comprises at least one of:
coupling one of two adjacent ramps;
coupling one of three adjacent ramps; and
coupling one of four adjacent ramps,
to at least one of the radially outer surface, the at least one adjacent vane, and the shroud.

18. The method according to claim 16, wherein positioning a plurality of adjacent supersonic compression ramps within the fluid flow channel comprises at least one of:
coupling at least one axial compression ramp to at least one radial compression ramp;
coupling at least one axial throat portion to at least one radial throat portion; and
coupling at least one axial diverging portion to at least one radial diverging portion.

19. The method according to claim 16 further comprising coupling at least one sealing mechanism to at least a portion of the shroud, wherein the at least one sealing mechanism includes at least one of at least one axial seal and at least one radial seal.

20. The method according to claim 16, wherein positioning a plurality of adjacent supersonic compression ramps within the fluid flow channel comprises forming a compression region within the fluid flow channel that facilitates forming at least one of a plurality of axial oblique shockwaves and a plurality of radial oblique shock waves.
